(19) United States
(12) Patent Application Publication
(10) Pub. No.: US 2022/0217999 A1
(43) Pub. Date: Jul. 14, 2022

(54) METHOD FOR PROTECTING PROTEIN FROM HEAT DAMAGE AND REDUCING RUMEN DEGRADABILITY OF METHIONINE

(71) Applicant: AJINOMOTO CO., INC., Tokyo (JP)

(72) Inventors: Paul SUMMER, Itasca, IL (US); Robert REED, Itasca, IL (US); Tomo TAKAGI, Chicago, IL (US); Jessica TEKIPPE, Chicago, IL (US)

(73) Assignee: AJINOMOTO CO., INC., Tokyo (JP)

(21) Appl. No.: 17/706,007

(22) Filed: Mar. 28, 2022

Related U.S. Application Data
(63) Continuation of application No. PCT/US2020/053535, filed on Sep. 30, 2020.
(60) Provisional application No. 62/908,884, filed on Oct. 1, 2019.

(51) Int. Cl. A23K 20/142; A23K 10/38; A23K 40/00; A23K 50/10

(52) U.S. Cl. CPC A23K 20/142; A23K 50/10; A23K 40/00; A23K 10/38

(57) ABSTRACT

Protein-containing feedstuffs which contain at least one protein feed material and either methionine or at least one feed product which contains methionine are resistant to reduction of digestibility as a result of heat damage during drying.

### CROSS REFERENCES TO RELATED APPLICATIONS

This application is a Continuation of International Patent Application No. PCT/US2020/053535, filed on Sep. 30, 2020, and claims priority to U.S. Provisional Patent Application No. 62/908,884, filed on Oct. 1, 2019, both of which are incorporated herein by reference in their entireties.

### BACKGROUND OF THE INVENTION

### Field of the Invention

The present invention relates to methods for protecting protein from heat damage and for reducing rumen degradation of methionine. The present invention also relates to protein-containing feedstuffs with resistance to lowered digestibility due to heat damage and to methionine-containing feedstuffs with resistance to rumen degradability. The present invention also relates to methods for preparing such feedstuffs.

### Discussion of the Background

Feedstuffs are used to feed and raise livestock. Such livestock can be harvested for its meat. Alternatively, livestock can be the source of produce such as eggs and milk, which may be consumed as milk, or converted into another dairy product, such as cheese or yogurt. To produce healthy livestock and increase the yield of produce, it is important for their feed to contain sufficient protein.

Recently, the production of ethanol from corn has become commercially important. In the dry milling (mash distillation) production of ethanol from corn, the process begins by grinding corn into a coarse flour. After the flour is combined with water and/or enzymes to convert the starch to sugar, the product is sterilized and then cooled. After yeast fermentation, ethanol is distilled from the mash. The residual mash is sent to either a centrifuge or screen press to remove as much liquid as possible, resulting in a liquid and wet distillers grain (“wet cake”). The liquid, referred to as corn distillers solubles may be condensed to obtain a syrup. The corn distillers solubles or syrup may be returned to process or sold as a feed additive. The wet distillers grains may also be sold as livestock feed or dried to afford dried distillers grains (DDG). The combination of condensed syrup with wet grains can be sold as is or further dried (DDGS) and the ratio of syrup to wet grains is typically 50:50 as is and also roughly 50:50 on a dry basis.

The DDG is a good source of protein, and it would be desirable to use the DDG as a component of a diet for livestock. However, to make efficient use of DDG in the production of a feed for livestock, the DDG must be dried. Such drying can lead to heat damage of the protein which can, in turn, lead to decreased digestibility of the protein, decreased growth of the livestock, and/or decreased milk production (see Nakamura, et al., J. Anim Sci., vol. 72, pp. 774-782 (1994) and D. H. Kleinschmit, et al., J. Dairy Sci., vol. 90, pp. 2909-2918 (2007), both of which are incorporated herein by reference in their entireties).

In particular, application of heat to protein is generally known to increase the rumen un-degraded protein (“RUP”) or protein which escapes digestion by rumen microbes. Heat treatment also decreases the intestinal digestion of the proteins that escape rumen degradation, especially in those feedstuffs high in sugars, such as distillers grains. Sugars form indigestible Maillard products with proteins during excess heating.

U.S. Pat. Nos. 5,709,894; 6,514,521; and 6,858,239, all of which are incorporated herein by reference in their entireties, disclose ruminant feed supplements prepared by drying a mixture of glutamic acid fermentation solubles and corn fermentation solubles on a wheat middlings carrier. U.S. Pat. No. 6,709,481, which is incorporated herein by reference in its entirety, discloses soil adjuvants prepared in the same way. Corn fermentation solubles are a liquid byproduct of the manufacture of amino acids using corn sugar as a raw material and include very small amounts of protein. Wheat middlings are low in crude protein (17.4 wt. % protein on dry matter basis (see “Nutrient Requirements of Beef Cattle,” Table 11-1—Means and Standard Deviations for the Composition of Data of Feeds Commonly Used in Beef Cattle Diets, National Academy Press (1996) which is incorporated herein by reference in its entirety) and not considered a protein-rich feedstuff. Thus, these references do not contain any disclosure of stabilizing the proteins in a protein-rich material during drying.

In the ruminant animal, ingested feed first passes into the rumen where it is partially broken down by bacterial fermentation. During rumen fermentation, rumen microbes utilize nitrogen from nitrogen compounds that they have degraded to form microbial protein. Nitrogen sources for rumen microbes include protein that is degraded in the rumen, rumen degradable peptides, free amino acids such as crystalline amino acids, and urea. Microbial protein and un-degraded feed protein pass to the abomasum and small intestine where hydrochloric acid and mammalian enzymes degrade microbial protein and un-degraded feed protein to free amino acids and short peptides. The amino acids and short peptides are absorbed in the intestine, and the ruminant animals utilize the amino acids for synthesis of protein to sustain life, grow, reproduce and produce milk. However, if the amino acid has been metabolized by rumen microbes, its value to the host animal is reduced.

Essential amino acids are those which are not produced de novo by the animal, and must be supplied by microbial protein or rumen un-degraded protein. Failure to provide certain essential amino acids in adequate amounts results in the animal being limited on the amount and types of protein it can produce. Supplying the proper amounts of amino acids maximizes animal performance while enhancing efficiency of energy utilization by the animal.

Dry-grind corn to ethanol plants produce about 17 lbs. of coproduct dried distillers grains with solubles (DDGS) for every bushel of corn processed into ethanol. The U.S. ethanol industry produces approximately 35-40 million metric tons of DDGS annually. Of this, about 25-30 million metric tons are utilized by the U.S. livestock industry and about 30% of this is used in dairy cattle rations. The remainder of DDGS is exported as a feedstuff. The coproduct DDGS typically contains 30% crude protein and 0.5% methionine and 0.9% lysine.

Methionine and lysine are the first and second limiting amino acids, respectively, in typical lactating dairy cow diets. Methionine requirements are met with feedstuffs high in methionine such as blood meal, fish meal, poultry byproduct meal or corn gluten meal. Also, commercially available rumen protected methionine products are commonly used and help reduce the reliance upon animal proteins in the food production chain. Lysine requirements can be met with blood meal, meat and bone meal, fish meal, canola meal and soybean meal. As with methionine, there are commercially available rumen protected lysine products and these are commonly used, especially when the commodity prices of animal proteins are high or when there is a desire to remove animal proteins from lactating dairy cow diets.

Feeding rumen protected methionine and lysine allows dairy producers to meet the requirements of these amino acids more specifically compared with protein feedstuffs and also to lower the total crude protein fed to cows. Total cost of milk produced dictates the choice of protein source and level in diets. Distillers grains are relatively low in cost compared with other protein sources but the coproduct is also relatively low in methionine and lysine and therefore they do not conveniently supply adequate levels of these first and second limiting amino acids without overfeeding crude protein. In addition, DDGS have a reputation of having a high amount of variability in protein digestibility, primarily due to heat damage during drying. This in turn, leads to decreased growth of livestock or decreased milk production.

Methionine is one of the most limiting essential amino acids when corn-based rations are fed. However, feeding unprotected methionine directly to ruminant animals does not increase the supply of absorbable methionine due to rumen bacteria utilizing free amino acids as a source of nitrogen for synthesis of microbial protein. Thus, in order to increase the supply of absorbable methionine to the ruminant, the methionine must be protected from microbial degradation in the rumen so it can pass into the intestine.

Coating biologically active substances with material that survives the rumen but degrades in the abomasum has been previously described. For example, see U.S. Pat. Nos. 3,541,204; 3,959,493; 4,642,317; 4,713,245; 4,808,412; 4,832,967; 4,876,097; 5,093,128; 5,145,695; 5,227,166; 5,496,571; 5,714,185; 5,807,594; 6,022,566; 6,229,031; 6,242,013; and 10,363,233, and U.S. Patent Application Publication No. 2002/0127259, all of which are incorporated herein by reference in their entireties.

Thus, there remains a need for protein-containing feedstuffs which exhibit good digestibility and are resistant to reduction of digestibility as a result of heat damage during drying.

In particular, there remains a need for feedstuffs which contain DDG which does not exhibit lowered digestibility due to heat damage during the drying process.

There also remains a need for feedstuffs which contain methionine as an additive and which exhibit reduced degradation of digestion of the methionine in the rumen.

There also remains a need for processes for making such feedstuffs.

There also remains a need for a DDGS coproduct with high digestibility and low susceptibility to heating damage during drying that is also high in methionine, the first limiting amino acid in typical lactating dairy cow diets.

### SUMMARY OF THE INVENTION

Accordingly, it is one object of the present invention to provide novel feedstuffs.

It is another object of the present invention to provide novel protein-containing feedstuffs.

It is another object of the present invention to provide novel protein-containing feedstuffs, which are resistant to heat damage during drying.

It is another object of the present invention to provide novel protein-containing feedstuffs which are resistant to reduction of digestibility as a result of heat damage during drying.

It is another object of the present invention to provide novel protein-containing feedstuffs which contain dried distillers grain (DDG) which exhibits decreased reduction in digestibility dues to heat damage during the drying process.

It is another object of the present invention to provide protein-containing feedstuffs which contain added methionine.

It is another object of the present invention to provide protein-containing feedstuffs which contain added methionine which exhibit reduced degradation and/or digestion of the methionine in the rumen.

It is another object of the present invention to provide novel processes for making such feedstuffs.

It is another object of the present invention to provide novel processes for raising livestock by feeding livestock such a protein-containing feedstuff.

These and other object, which will become apparent during the following detailed description, have been achieved by the inventors' discovery that the addition of methionine to corn distillers grains had the surprising effect to attenuate the reduction in protein digestibility caused by heat damage.

Thus, the present invention provides:

(1) A protein-containing feedstuff, comprising:

(a) at least one protein feed material; and

(b) added methionine or at least one feed product which contains the added methionine;

wherein:

the protein-containing feedstuff comprises the added methionine in an amount of not less than 1 gram of methionine per 100 grams of protein in the protein-containing feedstuff; and

the protein-containing feedstuff comprises at least 20 wt. % protein on a dry matter basis.

(2) A process for making a protein-containing feedstuff, said process comprising:

(i) mixing (a) at least one protein feed material with (b) added methionine or at least one feed product which contains methionine, to obtain a mixture; and

(ii) drying said mixture, to obtain said protein-containing feedstuff,

wherein:

the protein-containing feedstuff comprises the added methionine in an amount of not less than 1 gram of methionine per 100 grams of protein in the protein feed material; and

the protein-containing feedstuff comprises at least 20 wt. % protein on a dry matter basis.

(3) A protein-containing feedstuff, which is prepared by a process comprising:

(i) mixing (a) at least one protein feed material with (b) added methionine or at least one feed product which contains methionine, to obtain a mixture; and

(ii) drying said mixture, to obtain said protein-containing feedstuff,

wherein:

the protein-containing feedstuff comprises the added methionine in an amount of not less than 1 gram of methionine per 100 grams of protein in the protein-containing feedstuff; and

the protein-containing feedstuff comprises at least 20 wt. % protein on a dry matter basis.

(4) A process for raising livestock, comprising:

feeding livestock a protein-containing feedstuff, wherein said protein-containing feedstuff comprises:

(a) at least one protein feed material; and

(b) added methionine or at least one feed product which contains methionine,

wherein:

the protein-containing feedstuff comprises the added methionine in an amount of not less than 1 gram of methionine per 100 grams of protein in the protein-containing feedstuff; and

the protein-containing feedstuff comprises at least 20 wt. % protein on a dry matter basis.

Thus, the present invention provides a DDGS composition that can be dried with reduced heating damage and higher digestibility that also contains added DL-Met with resistance to rumen degradation. The added methionine protects corn proteins, at least partially, from heat damage leading to reduced digestibility. Not to be bound by this theory, the solubles or syrup may also bind with the small, hydrophobic methionine molecule casing it to be at least partially resistant to degradation in rumen fluid. Rumen-un-degraded methionine passes to the omasum and small intestine of cows where it is absorbed to meet methionine requirements of the animal. It is also possible the methyl group of methionine is reacting chemically with specific amino acids in DDGS protein to change the folding caused by heating the protein. Further, it has been demonstrated that methionine has some effect to reduce Maillard reactions during heating amino acids in the presence of reducing sugars.

### BRIEF DESCRIPTION OF THE DRAWINGS

A more complete appreciation of the invention and many of the attendant advantages thereof will be readily obtained as the same become better understood by reference to the following detailed description when considered in connection with the accompanying drawings, wherein:

FIG. 1 shows the content of acid detergent insoluble crude protein (ADICP) in DDGS samples at Midpoint (low heat exposure, still wet) and Final (high heat exposure, fully dried and heat exposed) of samples with typical (50:50) wet cake to syrup ratio from Example 2.

FIG. 2 shows the content of ADICP in DDGS samples created with a higher level of syrup (1.2×) and treated with 2% methionine and with or without 2% lysine base from Example 2.

### DETAILED DESCRIPTION OF THE PREFERRED EMBODIMENTS

Thus, in a first embodiment, the present invention provides novel protein-containing feedstuffs comprising (a) at least one protein feed material; and (b) added methionine or at least one feed product which contains the added methionine.

### A. Protein Feed Material

In the context of the present invention, the tetta “protein feed material” refers to any material which may be used as part of a diet for livestock and contains at least 20 wt. %, preferably at least 24 wt. %, even more preferably at least 28 wt. % protein on a dry matter basis.

Suitable examples of such protein feed materials are distillers grains or any fraction of grains resulting from the industrial production of ethanol. The term “distillers grains” means a coarse grain fraction separated from a whole stillage resulting from the production of ethanol. The production of ethanol may include production of ethanol from, for example, corn, wheat, milo, sorghum, rice, and/or barley. The term “corn distillers grains” means distillers grains when the raw material is corn.

Furthermore, the term “distillers grains plus solubles” is sometimes described as “distillers grains with solubles” and means a coarse grain fraction separated from a whole stillage resulting from the production of ethanol with the soluble fraction from the whole stillage which has typically been condensed to reduce total moisture. The term “corn distillers grains plus solubles” means distillers grains plus solubles when the raw material is corn.

Preferred examples of such protein feed materials are corn distillers grains and corn distillers grains plus solubles. In a preferred embodiment, the protein feed material contains grains which are the residue from distillation of ethanol produced by fermentation.

In another embodiment, the protein feed material may be soybean meal, canola meal, corn gluten meal, peanut meal, cottonseed meal, and a mixture thereof. The protein feed material may also be a more refined protein product, such as soy-protein isolate or soy-protein flour. These materials may be obtained as byproducts of oilseed crushing.

### B. Methionine

Methionine is an essential amino acid having the structural formula:

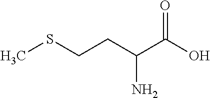

The methionine to be used in the present invention may be one extracted and purified from naturally-present animals, plants and the like, or one obtained by a chemical synthesis method, a fellnentation method, an enzyme method or a gene recombination method. For the purpose of imparting resistance to lowered digestibility due to heat damage, any of L-form, D-form, and DL-form can be used. For nutritional benefits, however, the L-form is preferred.

The methionine used in the present invention may be in the form of a salt. The form of the salt may be, for example, an acid addition salt, a salt with a base, and the like, and pharmacologically acceptable salts are preferable. Examples of such salts include salts with inorganic acids, salts with organic acids, salts with inorganic bases, and salts with organic bases.

Examples of the salt with an inorganic acid include salts with a hydrohalic acid (hydrochloric acid, hydrobromic acid, hydroiodic acid, etc.), sulfuric acid, nitric acid, phosphoric acid, and the like.

Examples of the salt with an organic acid include salts with formic acid, acetic acid, propionic acid, oxalic acid, succinic acid, maleic acid, fumaric acid, citric acid, and the like.

Examples of the salt with an inorganic base include salts with alkali metals such as sodium, potassium, lithium, and the like, salts with alkaline earth metals such as calcium, magnesium and the like, salt with ammonium, and the like.

Examples of the salt with an organic base include salts with ethylenediamine, propylenediamine, ethanolamine, monoalkylethanolamine, dialkylethanolamine, diethanolamine, triethanolamine, and the like.

The term “feed product which contains methionine” refers to hydrolyzed protein products containing free methionine such as hydrolyzed bacterial cell protein, hydrolyzed plant protein or others. Hydrolyzed corn proteins may be particularly high in methionine.

### C. Protein-Containing Feedstuff

In the context of the present invention, the term “protein-containing feedstuff” refers to any feedstuff which may be used as part of a diet for livestock and contains at least 20 wt. %, preferably at least 24 wt. %, and even more preferably at least 28 wt. % protein on a dry matter basis. Such protein-containing feedstuffs are sometimes referred to as “protein-rich feedstuffs.”

The moisture content of the protein-containing feedstuff is typically 0 to 20 wt. %, preferably 0 to 19 wt. %, more preferably 5 to 15 wt. %, and still more preferably 8 to 12 wt. %, based on the total weight of the protein-containing feedstuff.

When the methionine is used in the form of a salt, the amounts given above are calculated on the basis of free methionine.

Typically, the added methionine or feed product which contains methionine is present in the protein-containing feedstuff in an amount such that the amount of methionine is not less than 1 gram of methionine per 100 grams of protein in the protein-containing feedstuff, preferably 2 to 10 grams of methionine per 100 grams of protein in the protein-containing feedstuff, even more preferably 3 to 8 grams of methionine per 100 grams of protein in the protein-containing feedstuff, still more preferably 4 to 7 grams of methionine per 100 grams of protein in the protein-containing feedstuff.

In the context of the present invention, the term “added methionine” does not include any methionine which may be naturally occurring in the protein of the protein feed material.

### D. Additional Components

Of course, the protein-containing feedstuff of the present invention may also contain additional components, so long as they do not have an adverse effect. Examples of such additional components include vitamins, amino acids, preservatives, antibiotics, and any other ingredients conventionally added to feedstuffs. These additional components may be added in amounts conventionally used in feedstuffs.

In one embodiment, the protein-containing feedstuff of the present invention contains added L-lysine. L-lysine is an essential α-amino acid of the formula:

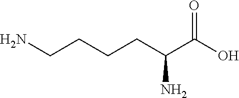

The lysine used in the present invention may be in the form of a salt. The form of the salt may be, for example, an acid addition salt and the like, and pharmacologically acceptable salts are preferable. Examples of such salts include salts with inorganic acids and salts with organic acids.

Examples of the salt with an inorganic acid include salts with a hydrohalic acid (hydrochloric acid, hydrobromic acid, hydroiodic acid, etc.), sulfuric acid, nitric acid, phosphoric acid, and the like.

Examples of the salt with an organic acid include salts with formic acid, acetic acid, propionic acid, oxalic acid, succinic acid, maleic acid, fumaric acid, citric acid, and the like.

In another embodiment, the lysine is present in a rumen-protected form. Methods of protecting active compounds in the rumen are disclosed in, e.g., U.S. Pat. Nos. 3,541,204; 3,959,493; 4,642,317; 4,713,245; 4,808,412; 4,832,967; 4,876,097; 5,093,128; 5,145,695; 5,227,166; 5,496,571; 5,714,185; 5,807,594; 6,022,566; 6,229,031; 6,242,013; and 10,363,233, and U.S. Patent Application Publication No. 2002/0127259, all of which are incorporated herein by reference in their entireties.

When present, the lysine, as the free form, a salt form, or a rumen-protected form, is typically present in an amount of 1 to 10 wt. %, preferably 2 to 6 wt. %, based on the total weight of the protein-containing feedstuff. When present as a salt or rumen-protected form, the amount of lysine is calculated on the basis of free lysine.

In another embodiment, the protein-containing feedstuff of the present invention contains betaine or at least one feed product which contains betaine. Betaine has been reported to ameliorate the lowering of digestibility of proteins, such as DGG, due to heating (see U.S. Pat. No. 10,251,411, which is incorporated herein by reference in its entirety.

In the context of the present invention, the term “betaine” means N, N, N, trimethylglycine which has the formula: (CH₃)₃N⁺CH₂CO₂H. The betaine may be used in the form of neutral zwitterions ((CH₃)₃N⁺CH₂CO₂⁻) or as an addition salt or as a mixture thereof. Alternatively, the betaine may be present as a component of a feed product which contains betaine.

Examples of suitable betaine or at least one feed product which contains betaine include betaine, amino acid fermentation byproduct solubles, molasses containing betaine, condensed separator byproduct, condensed molasses solubles, vinasse, or any mixture thereof. Preferred examples of feed products which contain betaine include a condensed, extracted glutamic acid fermentation product, amino acid fermentation byproduct solubles from the fermentative production lysine, amino acid fermentation byproduct solubles from the fermentative production threonine, or amino acid fermentation byproduct solubles from the fermentative production tryptophan. The condensed, extracted glutamic acid fermentation product is commercially available, for example, as PROTEFERM®.

Typically, the protein feed material and the betaine or feed product which contains betaine are mixed in a ratio such that the amount of betaine is not less than 3.5 grams of betaine per 100 grams of protein in the protein feed material, preferably 3.5 to 12.0 grams of betaine per 100 grams of protein in the protein feed material, even more preferably 4.0 to 8.0 grams of betaine per 100 grams of protein in the protein feed material, still more preferably 4.5 to 6.5 grams of betaine per 100 grams of protein in the protein feed material. When the protein feed material and the betaine or feed product which contains betaine are mixed, it is preferable in a ratio such that the amount of betaine is not less than 4.7 grams of betaine per 100 grams of protein in the protein feed material, more preferably 4.7 to 6.2 grams of betaine per 100 grams of protein in the protein feed material.

### E. Method of Making the Protein-Containing Feedstuff

In another embodiment, the present invention provides processes for making a protein-containing feedstuff, comprising (i) mixing (a) at least one protein feed material with (b) methionine or at least one feed product which contains methionine to obtain a mixture, and (ii) drying the mixture to obtain the protein-containing feedstuff.

The same “protein feed material”, “methionine”, “feed product which contains methionine”, “protein-containing feedstuff”, and optional components described above in connection with the protein-containing feedstuff may be used in the processes for making the protein-containing feedstuff.

Typically, the protein feed material will have, at the time it is mixed with the methionine or feed product which contains methionine, a moisture content of 10 to 90 wt. %, preferably 20 to 90 wt. %, more preferably 20 to 80 wt. %, and still more preferably 30 to 70 wt. %, based on the total weight of the protein feed material.

The feed product which contains methionine may have a moisture content of 0 to 95 wt. %, preferably 5 to 95 wt. %, more preferably 10 to 75 wt. %, and still more preferably 25 to 65 wt. %, based on the total weight of the feed product which contains methionine.

Typically, the protein feed material and the added methionine or feed product which contains methionine are mixed in a ratio such that the amount of methionine is not less than 1 gram of methionine per 100 grams of protein in the protein feed material, preferably 2 to 10 grams of methionine per 100 grams of protein in the protein feed material, even more preferably 3 to 8 grams of methionine per 100 grams of protein in the protein feed material, still more preferably 4 to 7 grams of methionine per 100 grams of protein in the protein feed material.

The mixing may be carried out in any suitable apparatus, such as a paddle mixer, ribbon mixer, plow mixer, v-type mixer, agitator mixer, conical mixer, pan mixer, zig-zag mixer, tumble mixer, or rotary mixer. When the protein feed material or the feed product which contains methionine is mixed in the wet state, the mixing is preferably carried out in a paddle mixer.

The protein feed material and the methionine or feed product which contains methionine are mixed in the same ratios described above in the context of the protein-containing feedstuffs.

When the protein feed material is in a wet state when mixed with the methionine or feed product which contains methionine, or when the feed product which contains methionine is mixed in the wet state, the resulting mixture may then be dried. The drying may be carried out in any suitable apparatus, such as a drum dryer, fluid bed dryer, belt dryer, disc dryer, flush dryer, rotary dryer, rotary vacuum dryer, steam tube dryer, tray dryer, turbo dryer, vacuum dryer or conical dryer. The drying is preferably carried out in a drum dryer.

The drying is suitably carried out by exposing the wet mixture to dry air having a temperature of 80 to 600° C., preferably 150 to 500° C., even more preferably 250 to 450° C., for a time of 1 to 60 minutes, preferably 2 to 30 minutes, even more preferably 4 to 10 minutes. The foregoing drying temperatures and drying times are suitable for commercial production of protein-containing feedstuffs according to the present invention. However, in the processes for making protein-containing feedstuffs according to the present invention, drying can be carried out at temperatures and for times outside of the ranges enumerated above. For example, when preparing smaller batches, as in the case of the Example described herein, it may be desirable to employ lower drying temperatures and longer drying times.

Typically, the resulting dried protein-containing feedstuff will have a final moisture content of 0 to 20 wt. %, preferably 0 to 19 wt. %, more preferably 5 to 15 wt. %, still more preferably 8 to 12 wt. %, based on the total weight of the protein-containing feedstuff.

When lysine is present in the protein-containing feedstuff, it is typically added after the drying step, in either free or rumen-protected form.

When betaine or a feed product which contains betaine is present in the protein-containing feedstuff, it is typically added before the drying step.

Particularly preferred embodiments are described below.

DL-Methionine (or D or L Methionine) is blended, mixed or otherwise incorporated into wet distillers grains in a uniform manner to create a homogenous mixture. The DL-Met can also be added to the distillers solubles fraction before adding to the wet cake or blended with the wet cake only.

DL-Met is added in an amount equal from about 0.5 to 3%, more preferably 1 to 2%, on a dry matter basis to DDGS or DDG without added solubles. The mixing may be carried out in any suitable apparatus, such as a paddle mixer, ribbon mixer, plow mixer, v-type mixer, pan mixer, zig-zag mixer, tumble mixer, rotary mixer or liquid blender. The preferred method is to add the methionine to the distillers solubles using a liquid blender and subsequently added to wet cake before drying.

The moisture content of the wet cake is typically 20 to 80% and more typically 25 to 60% and even more typically 30 to 45%. The moisture content of distillers solubles is typically 10 to 60% and more typically 15 to 50% and even more typically 20 to 40%.

The pH of the wet cake is typically 2 to 8 and more typically 3 to 5. The pH of distillers solubles is typically 2 to 8 and more typically 3 to 5.

The wet distillers grain is subsequently dried using standard drying equipment. These include rotary drum dryer, paddle dryer, fluid bed dryer, rotary vacuum dryer, or conical dryer.

The drying is suitably carried out by exposing the wet mixture to dry air having a temperature of 80 to 600° C., preferably 150 to 500° C., even more preferably 180 to 220° C., for a time of 1 to 60 minutes, preferably 2 to 30 minutes, even more preferably 4 to 10 minutes. The foregoing drying temperatures and drying times are suitable for commercial production of DDGS according to the present invention. However, in the process of making DDGS+Met, drying can be carried out at temperatures and for times outside of the ranges enumerated above. The time and temperature of the drying process is adjusted to increase heat exposure as desired to increase the amount of corn protein that will be resistant to rumen degradation (RUP). It is generally known that heat exposure will increase the RUP of protein. In addition to increasing RUP, heat exposure also makes the protein more resistant to digestion by the animal's stomach and intestinal enzymes. The inclusion of DL Methionine will attenuate the decrease in enzymatic digestion. This process also makes DL Methionine more resistant to rumen digestion.

Typically, the resulting dried DDGS+Met feedstuff will have a final moisture content of 0 to 20 wt. %, preferably 0 to 19 wt. %, more preferably 5 to 15 wt. %, still more preferably 8-12 wt. % based on total weight.

The methionine enhanced DDGS with decreased heat damaged proteins may be transferred to the customer for blending into dairy cow rations. It can also be fed to other ruminants such as beef cattle, sheep and goats. The product can also be fed to non-ruminants such as swine or poultry. Preferably, prior to feeding to dairy cows, the methionine enhanced DDGS is blended with a rumen protected lysine product such as AjiPro-L® (Ajinomoto Animal Nutrition).

As shown in the Example below, the addition of methionine or a feed product which contains methionine to a protein feed material serves to protect the protein from heat degradation during the drying process such that the deterioration of the digestibility of the protein is inhibited.

In another embodiment, the present invention provides a protein-containing feedstuff is obtainable by process comprising: (i) mixing (a) at least one protein feed material with (b) methionine or at least one feed product which contains methionine, to obtain a mixture; and (ii) drying said mixture, to obtain said protein-containing feedstuff, wherein: the protein-containing feedstuff comprises the methionine in an amount of not less than 3.5 grams of methionine per 100 grams protein in the protein feed material; and the protein-containing feedstuff comprises at least 20 wt. % protein on a dry matter basis.

### F. Raising Livestock

In another embodiment, present invention provides novel processes for raising livestock by feeding livestock such a protein-containing feedstuff. Such livestock includes cattle, oxen, bison, deer, pigs, goats, sheep, lambs, rabbits, lama, alpaca, foxes, mink, ermine, weasel, stoat, chinchilla, beavers, sables, otters, kangaroos, yaks, and fowl or poultry (including chickens, turkeys, ducks, game hens, ostrich, emu, and pheasants) and fish (including salmon, catfish, etc.) and reptiles (including alligators, crocodiles, lizards, snakes, etc.). In exemplary embodiments, livestock includes ruminant animals.

These livestock may be fed the protein-containing feedstuff of the present invention at any time and in any amount during their life. That is, the livestock may be fed the feedstuff of the present invention either by itself or as part of a diet which includes other feedstuffs. Moreover, the livestock may be fed the protein-containing feedstuff of the present invention at any time during their lifetime. The livestock may be fed the protein-containing feedstuff of the present invention continuously, at regular intervals, or intermittently. The livestock may be fed the protein-containing feedstuff of the present invention in an amount such that it accounts for all, a majority, or a minority of the protein in the livestock's diet for any portion of time in the animal's life. Preferably, the livestock is fed the protein-containing feedstuff of the present invention in an amount such that it accounts for a majority of the protein in the animal's diet for a significant portion of the animal's lifetime.

In another embodiment, the present invention provides novel processes for making meat by harvesting meat from livestock which have been fed such a protein-containing feedstuff. The livestock in this embodiment are the same as those described above in connection with the present process for raising livestock. The feeding may be carried out as described above in connection with the process for raising livestock.

The meat may be harvesting at any suitable time during the animal's lifetime. The harvesting of the meat may be carried out using the techniques conventional in the art of butchering. Typical meats to be harvested include, beef, pork, mutton, lamb, venison, bison, rabbit, chicken, turkey, duck, ostrich, emu, pheasant, etc. The meat may be sold fresh or frozen. The meat may be processed as described in Kirk-Othmer, Encyclopedia of Chemical Technology, Fourth Ed., Wiley-Interscience, NY, vol. 16, pp. 68-87, 1995, which is incorporated herein by reference.

In another embodiment, the present invention provides novel processes for making milk by harvesting milk from livestock which have been fed such a protein-containing feedstuff. The livestock in this embodiment are those which produce milk, such as cattle, oxen, bison, deer, pigs, goats, sheep, etc. The feeding may be carried out as described above in connection with the process for raising livestock. The harvesting of the milk may be carried out using the conventional techniques known to those in the art. The milk may be processed, stored, cooled, shipped, and packaged, as described in Kirk-Othmer, Encyclopedia of Chemical Technology, Fourth Ed., Wiley-Interscience, NY, vol. 16, pp. 700-746, 1995, which is incorporated herein by reference.

Other features of the invention will become apparent in the course of the following descriptions of exemplary embodiments which are given for illustration of the invention and are not intended to be limiting thereof.

### EXAMPLES

### Example 1

Using a sample of wet distillers grains (“DG”) was obtained from a commercial ethanol plant, treatments were applied in duplicates. The DG was treated with the three levels of DL-methionine shown in Table 1 and heated in an autoclave for 0.5 hour at 128° C. Following heat treatment, samples were dried in a forced oven set at 40° C. Dried samples were composited within treatment and analyzed for RUP and undigested total tract protein using a standard method. The results are shown in Table 1.

TABLE 1
Effect of DL-Methionine addition to distillers grains upon estimated rumen un-
degraded protein (RUP) and enzymatic digestion of RUP, after 0.5 hours of heat exposure
(128° C. autoclave).

| | | DL-Methionine (wt. %) | | |
|---|---|---|---|---|
| | Control | 1.0% | 1.5% | 2.0% |
| CP, % of DM | 29.94 | 31.22 | 30.90 | 31.90 |
| 16 hr. RUP, % of CP | 71.0 | 69.2 | 71.2 | 67.2 |
| RUP, % of DG Protein | 71.0 | 72.8 | 74.8 | 73.3 |
| RUP digestibility, g/100 g RUP | 63.8 | 72.1 | 67.8 | 72.7 |
| Undigested CP, % of CP | 25.7 | 19.3 | 22.9 | 18.3 |
| Calculated IAP¹, g/100 g distillers | 13.6 | 15.7 | 15.2 | 16.0 |
| grains | | | | |
| Undigested CP, % of feed DM | 7.70 | 6.02 | 7.08 | 5.85 |

¹IAP - Intestinally available protein
CP = crude protein
DM = dry matter

As can be seen, the amount of RUP among treatments was similar. However, the amount of total un-digested protein (higher digestibility) was reduced in all levels of added DL-methionine compared with Control and was 28% lower at the highest level of DL-methionine. Consequently, the calculated digestibility of RUP was higher at all levels of added DL-methionine compared with the Control and was highest for 2% DL-methionine which was 13.9% higher compared with Control. In addition, the total metabolically available protein was 17% higher in the 2% DL-methionine sample compared with Control. The actual amount of methionine in the RUP portion was not measured, but it is speculated to be higher compared with Control.

### Example 2

### Materials and Methods

Seven treatment conditions were applied to produce dried distillers grains with solubles (DDGS) at a pilot plant using wet cake and syrup from a commercial corn dry-mill ethanol plant. Table 2 shows the treatments. In each condition, the wet cake alone was sampled at time 0 minutes before loading into the dryer. The dryer was a steam jacketed paddle mixer type set at 200° C. The first pass of wet cake through the dryer resulted in about a 50% moisture reduction. At this time, the syrup was blended into the wet cake by metering it with a pump and spraying onto the wet cake as it entered the dryer for a second pass. Each condition contained different levels of added methionine designed to equal 0, 1.0, 1.5 or 2% on a dry matter basis with a wet cake to syrup ratio of 50:50 on a dry matter basis. Three conditions had a higher level of added syrup (1.2×) and either 0 or 2% DL methionine with or without 2% lysine base. A second, midpoint sample was collected from each after the second pass through the dryer. Several additional passes were conducted until dryness. Twenty-one samples were collected in total.

Subsamples of each condition were sent to an outside laboratory for in-vitro incubations with rumen fluid. About 400 mg were weighed into 50 ml polypropylene tubes. Rumen fluid was collected from cannulated cows that were fed a diet containing 50% concentrates. This was strained through cheeseclothe and 10 ml aliquoted into each tube in addition with 5 ml of McDougals buffer (sodium bicarbonate 9.8 g/L, sodium phosphate dibasic 2.4 g/L, potassium chloride 0.57 g/L, sodium chloride 0.47 g/L, magnesium sulfate heptahydrate 0.12 g/L, and calcium chloride 0.16 g/L) containing hydrazine and chloramphenicol to equal 1.0 mM and 30 μg, respectively, in the final volume. Hydrazine prevents uptake of ammonia by bacteria and chloramphenicol inhibits amino acid uptake and protein production. Each treatment condition was replicated 5 times in-vitro and a high rumen-undegradable soybean meal (SoyPlus®, Landus Cooperative™, Ralston, Iowa) was used as a check control along with 5 blanks Tubes were gassed with CO₂ to remove oxygen and placed into an oven at 39° C. on orbital shakers. Tubes were stoppered and the stoppers had gas reliefs fashioned from glass tubes with rubber policemen that were slit. The incubation period was 16 hours and incubations were stopped by the addition of 1.25 ml of 70% trichloroacetic acid. Tubes were swirled and allowed to stand for 30 minutes before freezing for later analyses.

Methionine and lysine in feed samples and rumen fluid incubated samples were analyzed using a Hitachi L-8900 amino acid analyzer with post-column ninhydrin derivatization (Hitachi High-Technologies Corporation. Tokyo, Japan). Sample preparation was done according to AAFCO 994.12. The rumen fluid digested samples were transferred from the 50 ml incubation tubes into 55 ml glass hydrolysis tubes and dried in a 80° C. forced-air oven (24-48 hours) to enable complete oxidation of methionine with perchloric acid prior to acid hydrolysis.

### Results

Table 3 shows the methionine and lysine content in each sample and SoyPlus®. The targeted added methionine content for Conditions 2, 3 and 4 was 1.0, 1.5 and 2.0%, respectively. The measured values were about right for Condition 2 but lower than expected for Conditions 3 and 4, indicating some challenge in blending the correct amount of amino acid into syrup and this syrup onto wet cake feed to meet a specific concentration target on a dry matter basis. The added methionine for Conditions 6 and 7 (2% added as a target) was also a little low; however, both conditions had more than 2% total methionine at their midpoint sample times. The added lysine for Condition 7 was close to the expected value.

Table 4 shows the amount of methionine or lysine remaining in the rumen digests as a percent of the amount added in the DDGS feed or SoyPlus® and adjusted for blank incubations. The check sample, SoyPlus® had values that are reasonable compared with the technical data sheet from the manufacturer of SoyPlus®. The technical data sheet claims a 60% RUP value for SoyPlus®. Methionine and lysine were measure to be 46.0 and 68.5% RUP, respectively, in this test. Methionine RUP in DDGS samples did not decrease with added methionine, indicating that the added methionine was nearly equally as undegradable as protein-bound methionine in DDGS. There was no clear trend for heating time, e.g., Pre vs. Midpoint vs. Final, on RUP methionine. The RUP lysine values in DDGS were all high except for Cond 7 wherein lysine base was added. The sharp decrease in RUP lysine in this sample indicates very little of the added lysine was rumen protected.

Table 5 shows the values used to calculate and the final calculation of RUP Met of the added methionine in Conditions 2, 3, 4, 6 and 7. Except for Cond.-6 Fin, all measured RUP values exceeded 50% of the added methionine. This indicates a commercially feasible and economically feasible level of RUP methionine using DDGS as a delivery method.

Table 6 shows the same calculations and result for RUP lysine in Condition 7. Very little of the added lysine was recovered in the rumen-fluid digested feed samples.

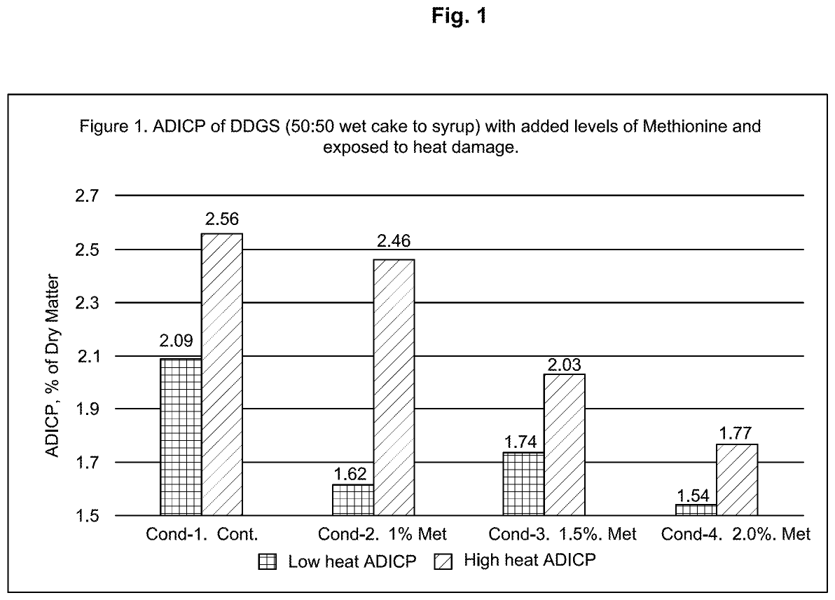

FIG. 1 shows the content of acid detergent insoluble crude protein (ADICP) in DDGS samples at Midpoint (low heat exposure, still wet) and Final (high heat exposure, fully dried and heat exposed) of samples with typical (50:50) wet cake to syrup ratio. Within each condition, a Midpoint sample and Final sample was collected and compared for ADICP. The analyte, ADICP is an indicator of heat damage (J. Dairy Sci. 98:6340-6360). Higher ADICP values indicate heat damage as the proteins become insoluble in acid detergent and these are considered undegradable in the rumen and nearly undigestible by the animal. All samples with methionine added had lower ADICP compared with Control Cond-1. The percentage increase from Midpoint (low heat) to Final (high heat) was lower in the middle (1.5%) and high (2.0%) methionine added samples compared with Control Cond-1. These data indicate DDGS dried with added methionine had lower heat damage and should be more digestible.

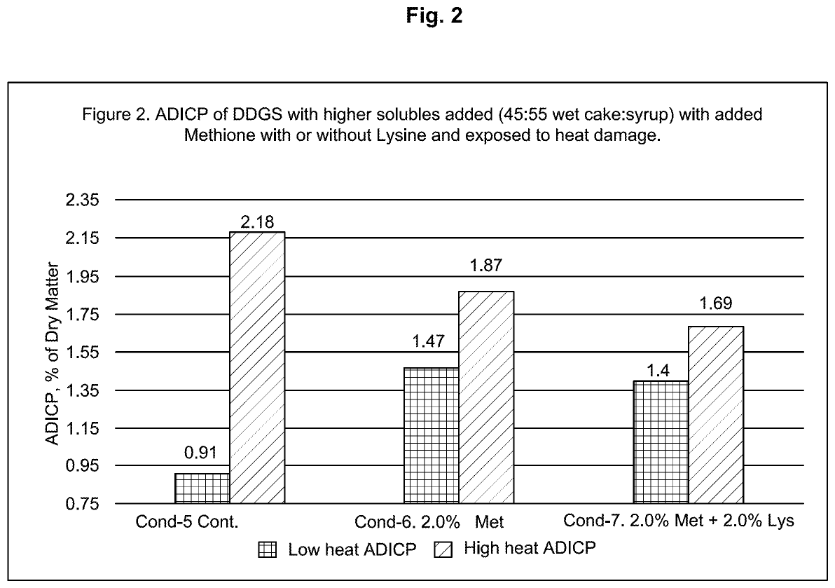

FIG. 2 shows the content of ADICP in DDGS samples created with a higher level of syrup (1.2×) and treated with 2% methionine and with or without 2% lysine base. In these samples, added methionine reduced total ADICP compared with Control Cond-5 and the percentage increase from Midpoint (low heat) to Final (high heat) was lower in methionine added DDGS.

TABLE 2
Treatment conditions to produce DDGS with added methionine or lysine.

| | Treatments | | | | | | |
|---|---|---|---|---|---|---|---|
| | | | | | Wet cake:stillage 45:55 | | |
| | Wet cake:stillage 50:50 | | | | | | Condition 7. |
| Sample | Condition 1 | Condition 2. | Condition 3. | Condition 4. | Condition 5. | Condition 6. | 2% DL-Met + |
| timing | 0% DL-Met | 1.0% DL-Met | 1.5% DL-Met | 2.0% DL-Met | 0% DL-Met | 2%-DL-Met | 2% Lysine |
| 0 minutes | Cond-1 Pre | Cond-2 Pre | Cond-3 Pre | Cond-4 Pre | Cond-5 Pre | Cond-6 Pre | Cond-7 Pre |
| Midpoint of | Cond-1 Mid | Cond -2 Mid | Cond-3 Mid | Cond-4 Mid | Cond-5 Mid | Cond-6 Mid | Cond-7 Mid |
| drying | | | | | | | |
| Final point | Cond-1 Fin | Cond-2 Fin | Cond-3 Fin | Cond-4 Fin | Cond-5 Fin | Cond-6 Fin | Cond-7 Fin |
| end of drying | | | | | | | |

TABLE 3
Methionine and lysine content of feeds.

| | | Treatments | | | | | | |
|---|---|---|---|---|---|---|---|---|
| | | | | | | Wet cake:stillage 45:55 | | |
| | | Wet cake:stillage 50:50 | | | | | | Condition 7. |
| Sample | | Condition 1. | Condition 2. | Condition 3. | Condition 4. | Condition 5. | Condition 6. | 2% DL-Met + |
| timing | SoyPlus ® | 0% DL-Met | 1.0% DL-Met | 1.5% DL-Met | 2.0% DL-Met | 0% DL-Met | 2%-DL-Met | 2% Lysine |

Methionine, % of dry matter

| | | | | | | | | |
|---|---|---|---|---|---|---|---|---|
| Pre | 0.60 | 0.47 | 0.54 | 0.48 | 0.45 | 0.53 | 0.46 | 0.53 |
| Midpoint | | 0.51 | 1.55 | 1.22 | 1.47 | 0.47 | 2.04 | 2.34 |
| Final | | 0.50 | 1.73 | 1.08 | 1.35 | 0.56 | 1.88 | 1.47 |

Lysine, % of dry matter

| | | | | | | | | |
|---|---|---|---|---|---|---|---|---|
| Pre | 2.70 | 0.72 | 0.70 | 0.81 | 0.61 | 0.79 | 0.68 | 0.80 |
| Midpoint | | 0.77 | 0.79 | 0.93 | 0.78 | 0.80 | 0.88 | 2.73 |
| Final | | 0.92 | 0.92 | 0.86 | 0.68 | 1.06 | 0.70 | 2.42 |

TABLE 4
Remaining methionine and lysine in tubes after 16 hour incubation with rumen fluid, g remaining/100 g of starting amount.

| | | Treatments | | | | | | |
|---|---|---|---|---|---|---|---|---|
| | | | | | | Wet cake:stillage 45:55 | | |
| | | Wet cake:stillage 50:50 | | | | | | Condition 7. |
| Sample | | Condition 1. | Condition 2. | Condition 3. | Condition 4. | Condition 5. | Condition 6. | 2% DL-Met + |
| timing | SoyPlus ® | 0% DL-Met | 1.0% DL-Met | 1.5% DL-Met | 2.0% DL-Met | 0% DL-Met | 2%-DL-Met | 2% Lysine |

Methionine, % RUP¹

| | | | | | | | | |
|---|---|---|---|---|---|---|---|---|
| Pre | 46.0 | 57.2 | 50.2 | 64.8 | 65.9 | 61.2 | 69.8 | 52.9 |
| Midpoint | | 56.4 | 60.2 | 60.9 | 54.9 | 62.5 | 58.8 | 58.6 |
| Final | | 60.2 | 58.9 | 67.2 | 59.7 | 58.7 | 51.9 | 55.5 |

Lysine, % RUP¹

| | | | | | | | | |
|---|---|---|---|---|---|---|---|---|
| Pre | 68.5 | 79.8 | 64.2 | 82.8 | 68.1 | 73.3 | 95.5 | 60.4 |
| Midpoint | | 80.7 | 79.7 | 69.4 | 76.7 | 72.6 | 57.7 | 22.8 |
| Final | | 77.8 | 62.9 | 75.2 | 85.4 | 77.3 | 74.9 | 16.0 |

TABLE 5
Calculated amount of rumen un-degraded methionine for added DL-methionine, % RUP Met.

| | Cond-2 | Cond-2 | Cond-3 | Cond-3 | Cond-4 | Cond-4 | Cond-6 | Cond-6 | Cond-7 | Cond-7 |
|---|---|---|---|---|---|---|---|---|---|---|
| Item, mg/tube | Mid | Fin | Mid | Fin | Mid | Fin | Mid | Fin | Mid | Fin |
| mg Met from | 2.46 | 2.46 | 2.24 | 2.24 | 2.12 | 2.12 | 2.01 | 2.01 | 2.46 | 2.46 |
| DDGS start¹ | | | | | | | | | | |
| RUP DDGS | 50.17 | 50.17 | 64.76 | 64.76 | 65.85 | 65.85 | 69.77 | 69.77 | 52.86 | 52.86 |
| Met, %² | | | | | | | | | | |
| Mg DDGS end³ | 1.24 | 1.24 | 1.45 | 1.45 | 1.39 | 1.39 | 1.4 | 1.40 | 1.30 | 1.30 |
| mg added Met⁴ | 4.76 | 4.83 | 3.47 | 2.56 | 4.70 | 4.00 | 7.53 | 6.40 | 8.32 | 4.30 |
| End mg Met | 4.35 | 4.3 | 3.48 | 3.23 | 3.75 | 3.65 | 5.61 | 4.37 | 6.31 | 3.75 |
| total⁵ | | | | | | | | | | |
| End mg Met | 3.11 | 3.06 | 2.03 | 1.7 | 2.35 | 2.26 | 4.21 | 2.96 | 5.01 | 2.45 |
| from added Met⁶ | | | | | | | | | | |
| % RUP Met⁷ | 65.32 | 63.39 | 58.36 | 69.53 | 50.12 | 56.48 | 55.78 | 46.31 | 60.25 | 57.05 |

¹Feed Met content in Pre sample * mg in incubation tube
²RUP Met content of sample PRE within each condition
³mg of feed Met * RUP
⁴mg of Met in sample—mg Met in DDGS only
⁵measured Met in incubated samples minus blanks
⁶tota1 end mg Met—mg Met from feed in end
⁷% RUP Met = end mg Met from added met/mg of added Met

TABLE 6
Calculated amount of rumen un-degraded
lysine for added lysine base, % RUP Lys.

| Item, mg/tube | Cond-7 Mid | Cond-7 Fin |
|---|---|---|
| mg Lys from DDGS start¹ | 0.80 | 0.80 |
| RUP DDGS Lys, %² | 60.41 | 60.41 |
| Mg DDGS end³ | 0.48 | 0.48 |
| mg added Lys⁴ | 7.27 | 6.16 |
| End mg Lys total⁵ | 2.36 | 1.47 |
| End mg Lys from added Lys⁶ | 1.87 | 0.99 |
| % RUP Lys⁷ | 25.75 | 16.04 |

¹Feed Lys content in Pre sample * mg in incubation tube
²RUP Lys content of sample PRE within each condition
³mg of feed Lys * RUP
⁴mg of Lys in sample - mg Lys in DDGS only
⁵measured Lys in incubated samples minus blanks
⁶total end mg Lys - mg Lys from feed in end
⁷% RUP Lys = end mg Lys from added lys/mg of added Lys

### INDUSTRIAL APPLICABILITY

Addition of methionine to distillers grains prior to drying or heat treating can increase the total amount of metabolizable protein in the feedstuff by preventing reductions in RUP digestibility. The addition of methionine to corn distillers grains may cause a great amount of the amino acid to become rumen un-degradable, or rumen protected.

Where a numerical limit or range is stated herein, the endpoints are included. Also, all values and subranges within a numerical limit or range are specifically included as if explicitly written out.

As used herein the words “a” and “an” and the like carry the meaning of “one or more.”

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A protein-containing feedstuff, comprising:
(a) at least one protein feed material; and
(b) methionine or at least one feed product which contains methionine;
wherein:
the protein-containing feedstuff comprises the methionine in an amount of not less than 1 gram of methionine per 100 grams of protein in the protein-containing feedstuff; and
the protein-containing feedstuff comprises at least 20 wt. % protein on a dry matter basis.

2. The protein-containing feedstuff according to claim 1, wherein said at least one protein feed material is distillers grains or any fraction of grains resulting from industrial production of ethanol.

3. The protein-containing feedstuff according to claim 2, wherein the grains are grains resulting from industrial production of ethanol from corn, wheat, milo, sorghum, rice or barley.

4. The protein-containing feedstuff according to claim 1, wherein said at least one protein feed material comprises corn distillers grains.

5. The protein-containing feedstuff according to claim 1, wherein said at least one protein feed material comprises corn distillers grains plus solubles.

6. The protein-containing feedstuff according to claim 1, wherein said at least one protein feed material comprises at least one material selected from the group consisting of soybean meal, soy-protein flour, soy-protein isolate, canola meal, corn gluten meal, peanut meal, and cottonseed meal.

7. The protein-containing feedstuff according to claim 1, wherein said protein feed material has a moisture content between 10 and 90 wt. %, based on the total weight of said protein feed material.

8. The protein-containing feedstuff according to claim 1, wherein said protein-containing feedstuff has a moisture content between 0 and 20 wt. %, based on the total weight of said protein-containing feedstuff.

9. The protein-containing feedstuff according to claim 1, which further comprises lysine.

10. The protein-containing feedstuff according to claim 9, wherein said lysine is present in a rumen-protected form.

11. The protein-containing feedstuff according to claim 1, which further comprises betaine or at least one feed product which contains betaine.

12. A process of making a protein-containing feedstuff, said process comprising:
(i) mixing (a) at least one protein feed material with (b) methionine or at least one feed product which contains methionine, to obtain a mixture; and
(ii) drying said mixture, to obtain said protein-containing feedstuff, wherein:
the protein-containing feedstuff comprises the methionine in an amount of not less than 1 gram of methionine per 100 grams of protein in the protein feed material; and
the protein-containing feedstuff comprises at least 20 wt. % protein on a dry matter basis.

13. The process of claim 12, wherein said drying is conducted with heating.

14. The process of claim 12, wherein said protein-containing feedstuff has a moisture content between 0 and 20 wt. %, based on the total weight of said protein-containing feedstuff.

15. The process according to claim 12, wherein said (a) protein feed material and said (b) methionine or at least one feed product which contains methionine are mixed in relative amounts such that a ratio of methionine to protein in said protein feed material is 2 to 10 grams of methionine to 100 grams of protein in said protein feed material.

16. A process according to claim 12, wherein said at least one protein feed material is distillers grains or any fraction of grains resulting from industrial production of ethanol.

17. A process according to claim 12, wherein said grains are grains resulting from industrial production of ethanol from corn, wheat, milo, sorghum, rice or barley.

18. A process according to claim 12, wherein said at least one protein feed material comprises corn distillers grains.

19. A process according to claim 12, wherein said at least one protein feed material comprises corn distillers grains plus solubles.

20. A process according to claim 12, wherein said at least one protein feed material comprises at least one material selected from the group consisting of soybean meal, soy-protein flour, soy-protein isolate, canola meal, corn gluten meal, peanut meal, and cottonseed meal.

21. A process according to claim 12, wherein said protein feed material has a moisture content between 10 and 90 wt. %, based on the total weight of said protein feed material.

22. A process according to claim 12, wherein said drying comprises exposing said mixture to an atmosphere having a temperature of 80 to 600° C.

23. A process according to claim 12, wherein said drying comprises exposing said mixture to an atmosphere having a temperature of 80 to 600° C. for a time of 1 to 60 minutes.

24. A process according to claim 12, wherein said drying comprises exposing said mixture to an atmosphere having a temperature of 80 to 250° C.

25. A process according to claim 12, wherein said drying comprises exposing said mixture to an atmosphere having a temperature of 80 to 150° C.

26. A process according to claim 12, wherein said drying comprises exposing said mixture to an atmosphere having a temperature of 150 to 250° C.

27. A process according to claim 12, wherein said protein-containing feedstuff has a moisture content of 0 to 19 wt. %, based on the total weight of said protein-containing feedstuff.

28. A protein-containing feedstuff, which is prepared by a process according to claim 12.

29. A method of raising livestock, comprising feeding said livestock a protein-containing feedstuff according to claim 1.
